(19) United States
(12) Patent Application Publication
(10) Pub. No.: US 2007/0141886 A1
(43) Pub. Date: Jun. 21, 2007

(54) Attachment part

(75) Inventors: Walter Hammer, Sollenau (AT); Dietmar Brandstatter, Markt Piesting (AT); Andreas Renner, Neunkirchen (AT)

Correspondence Address: HENRY M FEIEREISEN, LLC, 350 FIFTH AVENUE, SUITE 4714, NEW YORK, NY, 10118, US

(73) Assignee: Feller GmbH, Gunselsdorf (AT)

(21) Appl. No.: 11/611,478

(22) Filed: Dec. 15, 2006

(30) Foreign Application Priority Data
Dec. 20, 2005 (AT) A 2034/2005
Dec. 15, 2006 (AT) A 2072/2006

(51) Int. Cl. H01R 11/22

(52) U.S. Cl. 439/266

(57) ABSTRACT

In an attachment part (13) for an electrical plug-in connection, wherein a frame member (16) is provided having inside surfaces (17) which are formed to essentially match the outside contour of a first electrical connecting element (3), and wherein the frame member (16) can be attached to a second electrical connecting element (6) and forms with its inside surfaces (17) a through opening (18) in the connection direction of the electrical connecting elements (3, 6), and wherein the first electrical connecting element (3) can be guided so as to be freely movable, it is proposed for reducing manufacturing and material costs and for improving compatibility with existing plugs that a safety wire clip (90) is movably connected with the frame member (16), and that the safety wire clip (90) is formed so as to secure a first electrical connecting element (3) connected with the second electrical connecting element (6) so that it cannot be pulled out.

The invention relates to an attachment part for an electrical plug-in connection, wherein a frame member with inside surfaces which are formed to essentially match the outside contour of a first electrical connecting element is provided, and wherein the frame member can be attached to a second electrical connecting element and forms with its inside surfaces a through opening in the connection direction of the electrical connecting elements, and wherein the first electrical connecting element can be guided so as to be freely movable.

Attachment parts for electrical plug-in connections are disclosed, for example, in U.S. Pat. No. 5,507,664 which have a movable attachment made of plastic which can be used to secure a plug with an attached cable in a receptacle by pivoting the attachment over the plug and securing the attachment part piece on the cable. This type of attachment part disadvantageously has high manufacturing costs per unit, in particular for small batches, due to the material cost and in particular the cost for producing injection molding tools, as well as a limited compatibility with different plugs and more particularly with different cables. The plugs, but more particularly the cables from different manufacturers have rarely identical dimensions. An attachment part according to U.S. Pat. No. 5,507,664 designed for conventional cables is thus not applicable with thick, in particular shielded, cables typically used, for example, to supply power to electronic signal processing systems susceptible to interference, such as measurement amplifiers, radar systems, low temperature physics apparatuses or high-end stereo systems.

It is therefore an object of the invention to provide an attachment part for an electrical plug-in connection of the aforedescribed type which obviates the aforementioned disadvantages, which has low manufacturing and material costs, in particular in small batches, and which can reliably secure a majority of different plugs with cables of different thickness so that it cannot be pulled out.

This is achieved in accordance with the invention by movably connecting a safety wire clip with the frame member, and configuring the safety wire clip such that a first electrical connecting element connected with the second electrical connecting element is prevented from being pulled out.

In this way, an attachment part for an electrical plug-in connection can be formed which has low material and production costs. In particular, small batches of an attachment part according to the invention can be realized at low costs, which only slightly exceed the already low costs of a large scale production. In particular, with the attachment part according to the invention, fabrication of a costly and technically complex injection molding tool is no longer necessary. In particular small batches can then be produced profitably and within a short time. The ease of displacement ensures that the first electrical connecting element, for example an appliance receptacle mounted on one cable end, can be connected through the frame member with a second electrical connecting element, for example an appliance plug. In connected state, the frame member surrounds the inserted electrical connecting element and protects it from external and environmental effects.

In a modification of the invention, the safety wire clip may unblock in a first position the through opening for insertion of a first electrical connecting element, and in a second position may secure a first electrical connecting element connected with the second electrical connecting element from being pulled out. This enables simple insertion of the first electrical connecting element into the second electrical connecting element, which then is easily and reliably secured from being pulled out or becoming detached.

In this context, according to an improvement of the invention, the safety wire clip may be shaped so as to engage behind a first electrical connecting element connected with the second electrical connecting element. The first electrical connecting element is hereby secured on the surface, which is distal from the plug contacts, of a first electrical connecting element implemented as an appliance receptacle, wherein the secure attachment is independent of the employed cable or of the cable connected to the first connecting element, in particular its diameter, and can therefore be used with a variety of different connecting elements.

According to another embodiment of the invention, the safety wire clip may be rotatably supported on the attachment part by at least two bearings. This arrangement securely and firmly guides the safety wire clip.

According to yet another embodiment of the invention, the safety wire clip may have essentially the configuration of a U-shaped clip. The first electrical connecting element can thereby be easily and effectively attached and is also easy and inexpensive to manufacture.

According to a variant of the invention, the bridge of the clip may have a substantially U-shaped recess, wherein the leg of the recess may be arranged at least in certain regions substantially perpendicular to the bridge and the legs of the clip. The safety wire clip can then grip around the attachment area of a cable which increases the contact area, without completely encircling or enclosing the cable.

According to another configuration of the invention, the two substantially parallel legs of the U-shaped clip may be arranged in the second position of the safety wire clip in substantial parallel relationship to the connection direction of the electrical connecting elements. This enables essentially torque-free force transmission from the safety wire clip to the attachment part, again supporting high strain.

Advantageously, to avoid unnecessary downtimes of appliances, as well as to make the electrical appliance safer to use, a sealing element may be arranged on or adjacent to the inside surfaces of the frame member. The second electrical connecting element, for example an appliance plug, can thereby be implemented with a weather-proof protection, in particular according to IPX4. The seal can be formed so as to seal both the contact phase between an electrical appliance and the attachment part as well as a remaining gap between the inside surfaces of the frame member and the first electrical connecting element. The seal may also be formed so as to seal in addition the fastening screws and the provided screw holes. In this way, humidity or moisture is prevented from entering the appliance or the contacts when the electrical connecting elements are plugged together. Malfunctions and risk to personnel can thereby be reliably eliminated.

Advantageously, the frame member can be implemented as a closed ring, which reliably provides good all-around protection.

The frame member, preferably the entire attachment part, of conventional attachment parts can be implemented as a single piece. The attachment part can then be easily and cost-effectively manufactured. In addition, there are no additional joints requiring complex seals. By implementing the entire attachment part, including frame member and seal, as a single piece, the entire attachment part can be particularly quickly and economically produced, for example as a two-component injection molding part.

According to an improvement of the invention, the attachment part may include at least one fastener for securing the attachment part on the second electrical connecting element. As a result, the attachment part can remain connected with the second electrical connector, for example an appliance plug, even when the first electrical connector, for example the appliance receptacle mounted on a cable, is pulled away.

In this context, a projection or a flange, preferably with at least one opening, may be formed as fastener, by which the attachment part can be secured, in particularly screwed, on the second electrical connecting element. This enables a particularly secure and robust installation of the attachment part.

According to an advantageous variant, the attachment part may be formed to as to extend over fastening means of the second electrical connecting element, for example a catch or detent or a collar. This may provide a particularly effective seal, so that also a potential gap between the second electrical connecting element and a housing for disposition of this second electrical connecting element can be sealed.

In an especially preferred manner, the electrical connecting element may advantageously be selected from the following list of electrical plug-in systems: appliance plugs or appliance receptacles, in particular according to IEC 60320, particularly preferred according to IEC 60320-1, plugs and receptacles for cold appliances, plugs and receptacles for warm appliances, shockproof plugs and shockproof receptacles with or without ground wire, plugs and receptacles for hot appliances according to the 60320 standard, power extension cord plugs and receptacles according to IEC 60320-2.2. These electrical plug-in systems are standardized and alone cannot satisfy the object of the invention, i.e., preventing the receptacles from being pulled out and protecting against the environment. By installing a plug-in connection safety assembly according to the invention, these conventional plug-in safety assemblies can also be secured against unintentionally being pulled out, while still complying with the applicable standards.

The invention will now be described in more detail with reference to exemplary embodiments illustrated in the appended drawings. It is shown in:

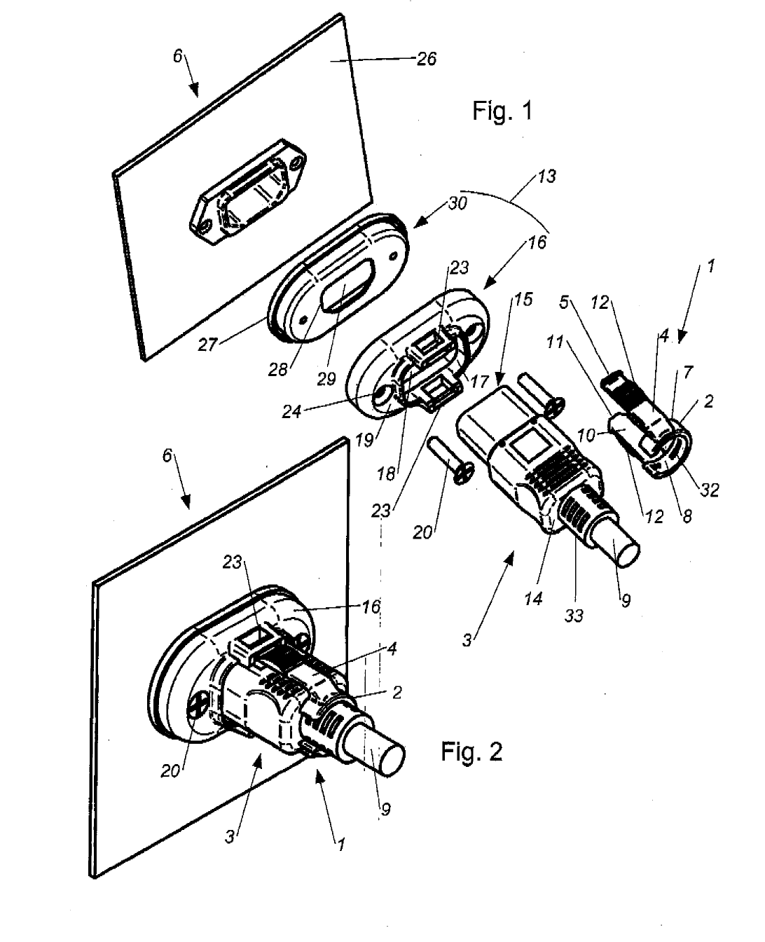

FIG. 1 in an exploded view, a system with a plug-in connection safety assembly and an attachment part for a straight appliance receptacle,

FIG. 2 a system of this type with attached electrical connecting elements,

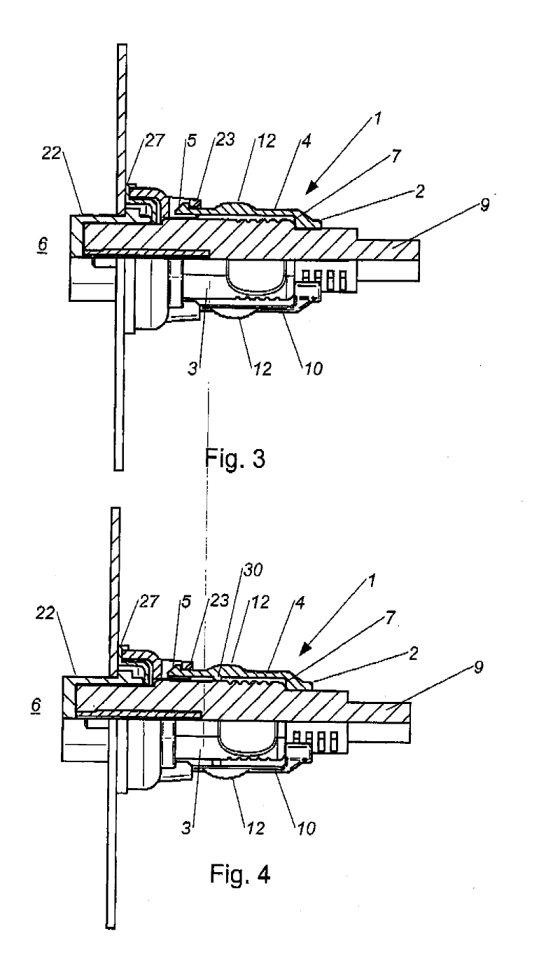

FIG. 3 a cross-sectional view of the system of this type with a plug-in connection safety assembly that can be pulled off without using a tool,

FIG. 4 a cross-sectional view of the system of this type with a plug-in connection safety assembly that can be pulled off only by using a tool,

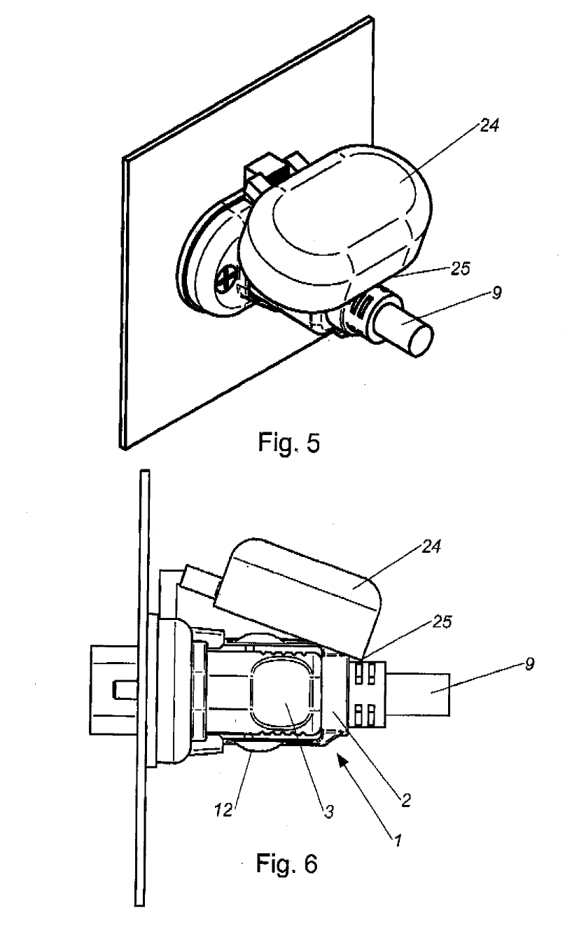

FIG. 5 a system of this type having in addition a cover, with attached electrical connecting elements,

FIG. 6 a side view of the system of FIG. 5,

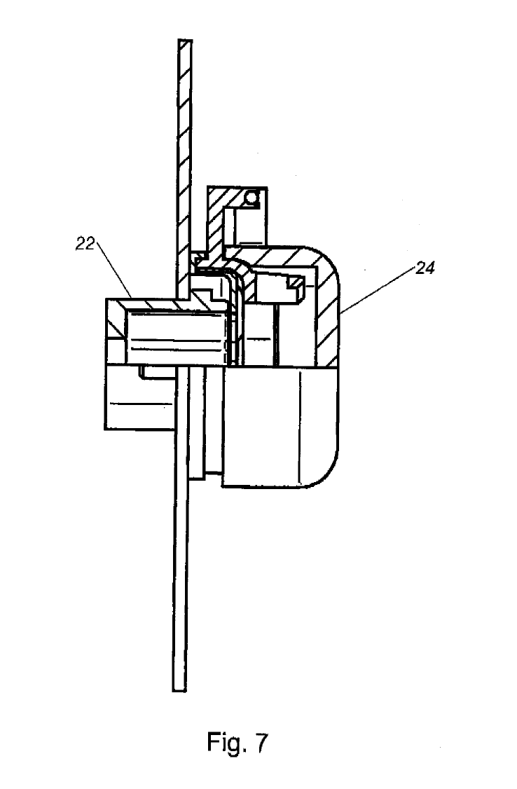

FIG. 7 a cross-sectional view of the system of FIGS. 5 and 6,

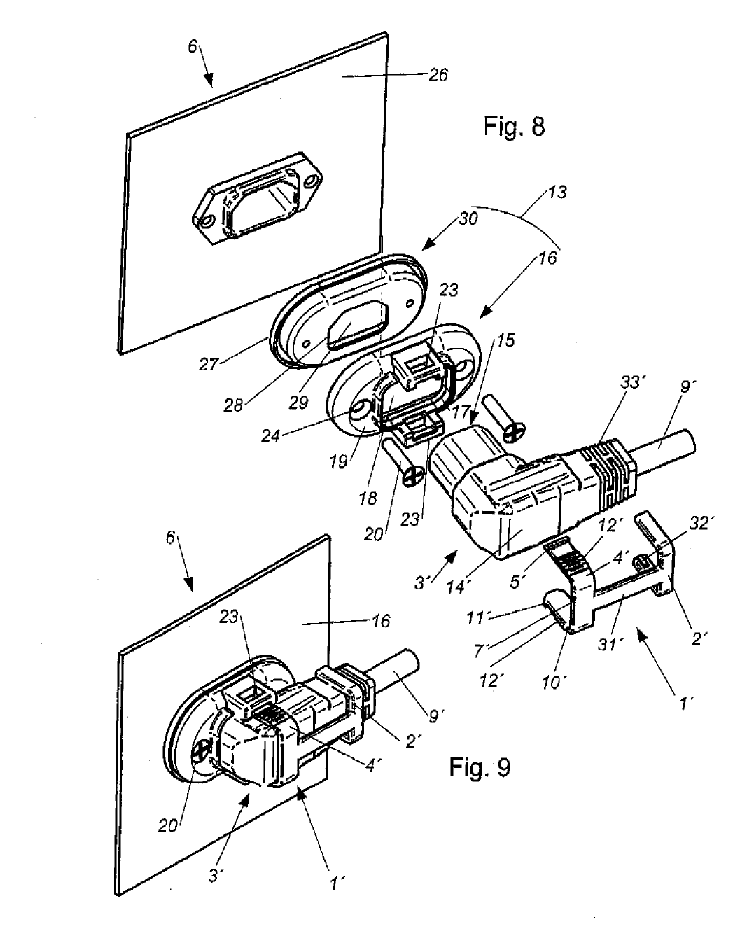

FIG. 8 an exploded view of a system with a plug-in connection safety assembly and an attachment part for an angled appliance receptacle,

FIG. 9 a system of this type with attached electrical connecting elements,

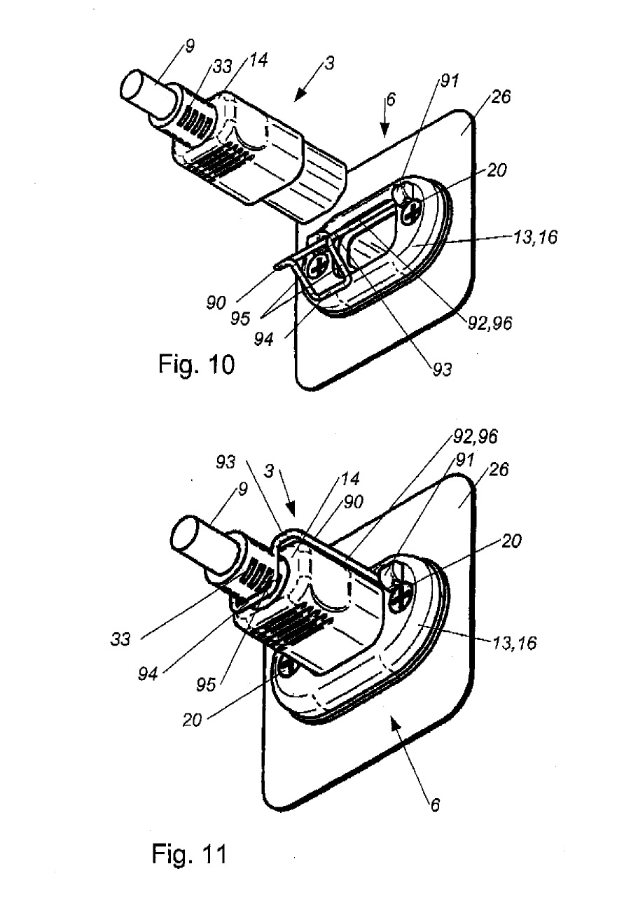

FIG. 10 an attachment part according to the invention with an electrical connector in axonometric view;

FIG. 11 an attachment part according to FIG. 10 with attached electrical connector; and

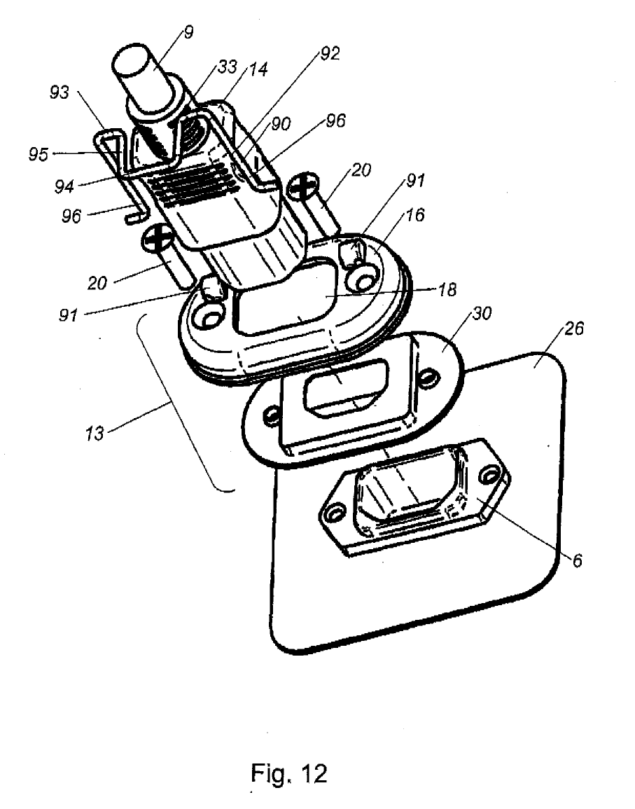

FIG. 12 an arrangement according to FIG. 10 in an exploded axonometric view.

The FIGURES show a plug-in connection safety assembly designated with reference sign 1. The safety assembly includes a holding member 2 as well as a first arm 4 and a second arm 10. Alternatively, only a single arm or more than two arms may be provided. The holding member 2 is approximately ring-shaped and has a support surface 7. The plug-in connection safety assembly can be placed over a first electrical connecting element, here implemented as an appliance receptacle 2 formed on a cable 9. When the plug-in connection safety assembly is completely pushed over the cable 9, the support surface 7 comes into contact with a surface 14 of the appliance receptacle 3 facing away from the plug contacts. The support surface 7 is here shaped like the appliance receptacle 3, in particular the surface 14. The holding member 2 can be formed as a closed ring or, as depicted in FIG. 1, as a lateral slitted ring. The lateral slit has the advantage that the holding member 1 can also be pushed later onto a cable 9, without having to remove a plug or a receptacle 3 on one or the other end of the cable 9. The holding member 2 is preferably anchored firmly on the cable 9 or in the grooves or openings of the appliance receptacle 3, so that the plug-in connection safety feature 1 remains secured to the appliance receptacle 3 even when the plug-in connection is pulled off. For this purpose, special anchoring bumps 32 are provided on the inside surface of the opening 8, which can engage in the spaces in the grooves or openings 33 of the appliance receptacle 3, i.e., in the grooves or openings of the strain relief bushing 33. Alternatively, the holding member 2 may also be slightly larger than the outside contour of cable 9 or of the grooves or openings of the appliance receptacle 3, so that the plug-in connection safety assembly 1 can still be moved on the appliance receptacle 3 as a result of the slight play.

A holding member in form of an outwardly projecting detent 5 or 11 is formed on the end of each of the arms 4 and 10. When the detents 5 and 11 of the arms 4 and 10 engage with a component that is connected with another electrical connecting element, the surface 14 of the appliance receptacle 3 facing away from the plug contacts can be supported on the support surface 7. When the detents 5 or 11 of the arms 4 and 10 are not anchored, the entire plug-in connection safety assembly 1 can be pulled off towards the rear, i.e., in a direction away from the electrical contacts. The plug-in connection safety assembly 1 can be freely displaced in that direction.

An engagement profile 12 is provided approximately in the center of each of the arms 4 and 10. In the depicted example, this profile is composed of a gripping bump 12. Alternatively, other shapes like, for example, a gripping indentation, a corrugation or any other shape providing a good grip is feasible. The plug-in connection safety assembly 1 can be easily gripped on these gripping bumps 12 so that the arms 4 and 10 can be pushed inward. This also decreases the distance of the detents 5 and 11 at the ends of the arms 4 and 10, so that these can be moved out of a gripping member 23.

FIG. 1 also shows an attachment part 13 which includes essentially a frame member 16 and a seal 30. The frame member 16 has a fastener in the form of a flange 19 having openings for receiving screws 20. The attachment part can be attached with the screws 20 on a second electrical connecting element 6. In the depicted exemplary embodiment, the second electrical connecting element is an appliance plug 6.

As an alternative to a securement with screws 20, other suitable fasteners may be contemplated, for example a snap-in or clamping attachment. The attachment part 13 may also be arranged directly on the appliance plug 6 or on the appliance housing associated with the appliance plug 6.

Interior surfaces 17 which are shaped similar to the exterior shape of the first electrical connecting elements, in this case the appliance receptacle 3, are formed on the frame member 16. The appliance receptacle 3 can be freely displaced through the through opening 18 formed by the interior surfaces 17. Therefore, no clamping or other fixed connection is provided between the first electrical connecting element itself and the frame member 16.

In addition, two opposing engagement members in the form of integrally formed webs 23 are provided on the frame member 16. Engagement members other than the webs 23 may be provided, for example a catch, a projection, an indentation, a groove, a notch, an undercut or any other form capable of locking a holding means, such as a catch. The frame member 16 in the exemplary embodiment is produced as a single component, for example by injection molding.

The attachment part 13 optionally includes a seal 30. This sealing element 30 is constructed so as to perform two sealing functions simultaneously. On one hand, it has a bead 27 sealing the joint between the frame member 16 and the region of the housing section of the appliance that is directly adjacent the second electrical connecting element. In the depicted example, this joint is located between the appliance plug 6 and the housing wall 26. On the other hand, the sealing element has a sealing lip 28 surrounding the through opening 29 which seals the gap provided for movement between the outside contour of the first electrical connecting element, in the depicted example the appliance receptacle 3, and the frame member 16. This arrangement completely seals the electrical plug-in connection, so that a weather-tight seal according to IPX4 can be achieved even with conventional plug-in connections corresponding to IEC 60320-1. As shown in the FIGURES, the seal 30 can be formed as a separate component. Alternatively, the seal 30 can also be formed with the frame element 16 as a unitary piece. To provide the aforedescribed sealing functions, the seal should be made of a material having a greater flexibility than the frame member 16. This can be achieved, for example, with a two-component injection molded part. In this way, a single piece attachment part 13 can be produced in a single fabrication step which is, however, composed of two parts, namely the seal 30 and frame member 16.

FIGS. 2 to 4 illustrate an appliance receptacle 3 connected with an appliance plug 6. The receptacle is held in place by the plug-in connection safety assembly 1 slipped over the cable 9. The detents 5 and 11 on the arms 4 and 10 snap in behind the webs 23.

In the embodiment according to FIG. 3, the plug-in connection safety assembly 1 and hence also the appliance receptacle 3 can be pulled off the appliance plug 6 without using a tool. To accomplish this, the arms 4 and 10 are pressed together at their gripping bumps 12, decreasing the distance between the detents 5 and 11. The detents 5 and 11 become hereby disengaged from the webs 23. Because the plug-in connector safety device 1 is thus no longer anchored on the attachment part 13, the appliance receptacle 3 can be pulled off.

In the embodiment according to FIG. 3, the plug-in connection safety assembly 1 and hence also the appliance receptacle 3 can be pulled off the appliance plug 6 only by using a tool. In this case, a projection 30 is formed on the inside of at least one arm, in the depicted example on the insides of the two arms 4 and 10, which prevents the arms 4 and 10 from being pressed together simply by using fingers. For example, a screwdriver, pliers or a similar tool can be used to disengage the detents 5 and 11. This makes it more difficult to pull the plug-in connection apart and provides increased protection against improper removal of the connection.

FIGS. 5 to 7 illustrate another embodiment with a cover in form of a flap 24. Alternatively, other forms of a cover would also be feasible, for example a clip-on cover, a sliding cover or the like. The illustrated flap 24 is supported on the attachment part 13 by a hinge disposed on the upper edge of the attachment part 13, allowing the flap to be moved back and forth between a first position closing the through opening 18 and a second position unblocking the through opening 18. Advantageously, the flap 29 can be biased toward its first position, i.e., in the closing direction. For example, a spring, in particular a coil spring arranged on the pivot axis or the like, can be provided.

The depicted attachment part 13 is configured for use with various electrical connecting elements. These may be, for example, appliance plugs that can be attached with screws or with a so-called snap-in connection. Integrated appliance plugs are also feasible. In particular, the attachment part 13 and optionally also the seal 30 are configured to cover and/or project over all alternate embodiments of appliance plugs. In particular, the depth and the dimensions of the attachment part 13 and the seal 30 are matched to those of the appliance plugs. In the solution employing a snap-in appliance plug, the seal 30 of the attachment part 13 can in addition to the aforedescribed sealing functions advantageously also seal the mostly slotted openings around the detents of the snap-in appliance plug. Accordingly, a single seal 30 can completely seal a conventional appliance plug.

Although the illustrated examples are directed to appliance plugs and appliance receptacles complying with the standard IEC 60320-1 with or without grounded contact, the invention can also be applied to other plug-in systems. The invention can therefore be employed with any other, standardized or non-standardized, past or future plug-in system. The attachment part 13 according to the invention can thus be used to convert a standardized, unprotected plug-in connection into a plug-in connection offering greater protection, for example weather-tight protection according to IPX4.

The depicted examples are intended to achieve weather-tight protection according to the protection class IPX4. Alternatively however, other classes of protection, for example IPX0, are possible. It would also be feasible to completely eliminate the illustrated seal 30 and to provide only the frame member 16. The cover 27 can optionally also be entirely eliminated. In particular, all sub-combinations of these and other described optional features are possible, whereby one feature, several features or all features may be incorporated. Additional embodiments according to the invention may include only a subset of the described features, wherein each combination of features, in particular also of different described embodiments, can be employed.

The plug-in connection safety assembly 1 and an attachment part 13 according to the invention can be used to construct a system for securing and protecting an electrical plug-in connection. The plug-in connection safety assembly 1 can cooperate with the frame member 16 of the attachment part 13 so that the first electrical connecting element, in the depicted exemplary embodiment the appliance receptacle 3, is held in the second electrical connecting element, in the depicted exemplary embodiment the appliance plug 6. When the plug-in connection safety assembly 1 is pushed over the cable 9 and over the connected appliance receptacle 3, it latches with the detents 5 or 11 arranged on the arms 4 and 10 behind the webs 23 of the frame member 16. The plug-in connection safety assembly 1 thereby grips around the appliance receptacle 3, preventing the same from being pulled off. Even when the cable 9 is pulled, the surface 14 of the appliance receptacle 3 is supported on the support surface 7 of the plug-in connection safety assembly 1. At the same time, the appliance receptacle 1 is always surrounded by the inside faces 17 of the frame member 16, covering the actual insertion opening of the appliance plug 6. In addition, the sealing element 30 seals the remaining gap between the inside faces 17 of the frame member 16 and the appliance receptacle 3. The combination of the plug-in connection safety assembly 1 with the attachment part therefore provides comprehensive protection of a standardized plug-in connection.

Another exemplary embodiment is illustrated in the FIGS. 8 and 9. In this embodiment, unlike the aforedescribed embodiments, the plug-in connection safety assembly 1′ is especially designed for angled electrical connecting elements, here for an angled appliance receptacle 3′. Like the straight embodiment depicted in FIGS. 1 and 2, the angled appliance receptacle 3′ attached to a cable 9′ is plugged into an identically shaped appliance plug 6. The attachment part 13 can also remain unchanged in this embodiment. Only the plug-in connection safety assembly 1′ is different from that of the straight embodiment. The plug-in connection safety assembly 1′ thus includes a support face 7′ which in the depicted embodiment does not have an opening. For attaching the plug-in connection safety assembly 1′ on the angled appliance plug 3′, a holding member 2′ is provided on the plug-in connection safety assembly 1′, which is implemented separately from the support surface 7′. Like in the embodiment for straight connection systems, two arms 4′ and 10′ with detents 5′ and 11′ formed on their ends are disposed following the support face 7′. A gripping pattern 12′ is formed approximately in the center of each of the arms 4′ and 10′ and can have, like in straight embodiments, different forms. In all other aspects, reference regarding the exact design of the arms 4′ and 10′ is made to the discussion of the arms 4 and 10 of the straight embodiment.

The holding member 2′ is here shaped to match the angled appliance receptacle 3′ or, more precisely, its grooves or openings. In the concrete example, the grooves or openings are sequentially arranged and have a rectangular, in particularly square cross-section. The holding member 2′ therefore has a likewise rectangular inside contour and is open on one side. It can be then pushed in the direction of this opening onto the grooves or openings of the angled appliance receptacle 3′. In the depicted embodiment, this direction is identical to the direction in which the arms 4′ and 10 can be pushed into suitable engagement means, in particular webs 23, of an attachment part 13. The plug-in connection safety assembly 1′ can thereby be attached on the angled appliance receptacle 3′ either before or after the angled appliance receptacle 3′ has been plugged in the appliance plug 6.

The holding member 2′ is preferably firmly anchored in the grooves or openings of the angled appliance receptacle 3′, so that the plug-in connection safety assembly 1′ remains secured on the angled appliance receptacle 3′ even after the plug-in connection has been pulled apart. Special anchoring bumps 32′ are here again provided on the interior faces of the holding member 2′, which can engage in the gaps of the grooves or openings 33′ of the angled appliance receptacle 3′, i.e., in the grooves or openings of the strain relief pushing 33′. Alternatively, the holding member 2′ can also be made slightly larger than the outside contour of the cable 9′ or of the grooves or openings of the angled appliance receptacle 3′, so the plug-in connection safety assembly 1′ can move on the angled appliance receptacle 3′ as a result of the slight play.

The holding member 2′ is connected with the support surface 7′ and the attached arms 4′ and 10′ via a connecting web 31′. The connecting web 31′ has a length matching the angled appliance receptacle 3′ so that, on one hand, the detents 5′ and 11′ of the arms 4′ and 10′ are supported on the webs 23 of the attachment part 13 and, on the other hand, the holding member 2′ can be anchored in the grooves or openings 33′ of the angled appliance receptacle 3′.

FIGS. 10 to 12 show the currently best known embodiment of an attachment part 13 for an electrical plug-in connection, with a frame member 16 having inside surfaces 17 which are essentially formed to match the outer contour of a first electrical connecting element 3, wherein the frame member can be secured on a second electrical connecting element 6 and forms with its inside surfaces 17 a through opening 18 in the connection directions of the electrical connecting elements 3, 6, and wherein the first electrical connecting element 3 can be guided to be freely movable, wherein a safety wire clip in 90 is movably connected with the frame member 16, and wherein the safety wire clip 90 is formed so as to be able to secure a first electrical connecting element 3, which is connected with the second electrical connecting element 6, from being pulled out.

In this way, an attachment part 13 for an electrical plug-in connection can be formed, which has low material and production costs. In particular, the attachment part 13 according to the invention enables small production batches, which can be manufactured at a cost only slightly above the already very low production cost for a large volume production. In particular, an attachment part 13 according to the invention does not necessitate the fabrication of an expensive and technically complex injection molding tool. Small batches can then be produced profitably and quickly. Due to the ease of movement, the first electrical connecting element 3, for example an appliance receptacle 2 mounted on one cable end, can be connected through the frame member 16 with a second electrical connecting element 6, for example an appliance plug 6, without jamming. When connected, the frame member 16 surrounds the plugged-in electrical connecting element 3 and protects it from external and environmental effects.

All aforedescribed embodiments of a first and/or second electrical connecting element 3, 6, in particular implemented as an appliance receptacle 2 or as an appliance plug 6, can also be provided with the described attachment part 13 according to the invention for an electrical plug-in connection. The safety wire clip 90 can include any type of wire, in particular metal wire, preferably steel wire or copper wire, which are able to withstand the expected load when an unauthorized attempt is made to disconnect the first electrical connecting element 3 from the second electrical connecting element 6. In addition, the safety wire clip 90 can be implemented to split under an applied load, for example when the cable 9 is pulled, which is lower than a load that could damage the second electrical connecting element 6 or the housing wall 26, or which would be necessary to tear or pull be connected device from its mount. In this case, the safety wire clip 90 may have at least one rated break point. This can prevent damage if, for example, an electric device is pulled from a mount by using the cable 9 or pulled from the table or another raised position, potentially damaging the device.

The safety wire clip 90 is shaped so as to engage behind a first electrical connecting element 3 that is connected with the second electrical connecting element 6. In particular, the safety wire clip 90 engages on the face 14 of the first electrical connecting element 3. Differently shaped safety wire clips 90 can be provided depending on the actual embodiment of the first electrical connecting element 3. To enable simple insertion of the first electrical connecting element 3 into the second electrical connecting element 6 and to simultaneously provide adequate safety, the safety wire clip 90 preferably unblocks in a first position the through opening 18 for insertion of a first electrical connecting element 3, and in a second position secures a first electrical connecting element 3 connected with the second electrical connecting element 6 to prevent it from being pulled out, wherein FIG. 10 shows the safety wire clip in the first position and FIG. 11 shows the safety wire clip 90 in the second position. The safety wire clip 90 is preferably rotatably supported in at least two supports 91 disposed on the attachment part 13. Preferably, friction in the two supports is so high that although the safety wire clip 90 can be rotated manually, it remains in a predeterminable position, without additional holding means and only through friction in the supports 91.

In a particular preferred embodiment of a safety wire clip 90 according to the invention, the safety wire clip 90 can have essentially the shape of a U-shaped clip 92. In a particularly preferred embodiment depicted in FIGS. 10 to 12, the bridge 93 of the clip has an essentially U-shaped recess 94, wherein at least in certain regions the arms 95 of the recess 94 are substantially perpendicular to the bridge 93 and to the legs 96 of the clip 92. This provides a particularly close and engaging contact of the safety wire clip 90 with the surface 14. With this shape of the safety wire clip 90, the two essentially parallel legs 96 of the U-shaped clip 92 are in the second position of the safety wire clip 90 oriented essentially parallel to the connection direction of the electrical connecting elements 3, 6, which can increase the load-bearing capacity of the attachment part because the force is essentially applied without a torque; due to the parallel arrangement relative to the first electrical connecting element 3, the safety wire clip 90 is particularly elegantly integrated with the overall concept.

In addition to the aforedescribed particularly preferred embodiment, the clip 92 may also be implemented as a simple U-shaped clip, which engages behind the first electrical connecting element 3 implemented as an appliance receptacle 2, wherein the leg 96 of the clip 92 in this embodiment is in the second position of the safety wire clip 90 not parallel to the connection direction of the electrical connecting elements 3, 6.

As discussed above, combinations of all aforedescribed embodiments as well as of portions of such embodiments can be provided within the context of the claims.

1. An attachment part for securing a first electrical connecting element to a second electrical connecting element, comprising:
a frame member adapted to be attached to the second electrical connecting element and having a through-opening with inside surfaces formed to essentially match an outside contour of the first electrical connecting element and allowing insertion of the first electrical connecting element through the through-opening for connection with the second electrical connecting element, and
a safety wire clip movably connected with the frame member and formed so as to engage the first electrical connecting element and prevent the first electrical connecting element from being pulled out when connected with the second electrical connecting element.

2. The attachment part according to claim 1, wherein the safety wire clip has a first unblocking position enabling insertion of the first electrical connecting element through the through-opening, and second blocking position in which the first electrical connecting element connected with the second electrical connecting element is prevented from being pulled out.

3. The attachment part according to claim 1, wherein the safety wire clip is shaped so as to engage behind the first electrical connecting element while connected with the second electrical connecting element.

4. The attachment part according to claim 1, further comprising at least two supports rotatably supporting the safety wire clip on the attachment part.

5. The attachment part according to claim 1, wherein the safety wire clip has an engagement portion essentially in the shape of a U-shaped clip.

6. The attachment part according to claim 5, wherein the U-shaped engagement portion includes a bridge and legs forming a substantially U-shaped recess, wherein the legs of the recess are arranged at least in certain regions substantially perpendicular to the bridge and to two substantially parallel legs of the safety wire clip that are disposed between the recess and the attachment part.

7. The attachment part according to claim 6, wherein the two substantially parallel legs of the U-shaped clip are in a blocking position of the safety wire clip aligned substantially parallel to a connection direction of the first and the second electrical connecting elements.

8. The attachment part according to claim 1, and further comprising a sealing element arranged on or adjacent to the inside surfaces of the frame member.

9. The attachment part according to claim 1, wherein the frame member is implemented as a closed ring.

10. The attachment part according to claim 1, wherein the attachment part includes at least one attachment means for securing the attachment part on the second electrical connecting element.

11. The attachment part according to claim 10, wherein the attachment means comprise a projection or a flange, by which the attachment part can be secured on the second electrical connecting element.

12. The attachment part according to claim 1, wherein the second electrical connecting element comprises an attachment means, and wherein the attachment part is formed to as to extend over the attachment means of the second electrical connecting element.

13. The attachment part according to claim 1, wherein the first electrical connecting element (3) is selected from the group of electrical plug-in systems consisting of appliance plugs or appliance receptacles, appliance plugs or appliance receptacles in compliance with IEC 60320 appliance plugs or appliance receptacles in compliance with IEC 60320-1, plugs and receptacles for cold appliances, plugs and receptacles for warm appliances, shockproof plugs and shockproof receptacles with or without ground wire, plugs and receptacles for hot appliances according to the 60320 standard, and power extension cord plugs and receptacles according to IEC 60320-2.2.

14. The attachment part according to claim 11, wherein the projection or a flange has at least one opening, by which the attachment part can be screwed on the second electrical connecting element.

15. The attachment part according to claim 12, wherein the attachment means of the second electrical connecting element comprise at least one of a catch, a detent, and a collar.
